(19) United States
(12) Patent Application Publication
(10) Pub. No.: US 2024/0176584 A1
(43) Pub. Date: May 30, 2024

(54) Scalable Switch Capacitor Computation Cores for Accurate and Efficient Deep Learning Inference

(71) Applicant: International Business Machines Corporation, Armonk, NY (US)

(72) Inventors: Chia-Yu Chen, Westchester, NY (US); Andrea Fasoli, San Jose, CA (US); Ankur Agrawal, Chappaqua, NY (US); Kyu-hyoun Kim, Chappaqua, NY (US); Chi-Chun LIU, Altamont, NY (US); Mauricio J. Serrano, Bronx, NY (US); Monodeep Kar, New York, NY (US); Naigang Wang, Ossining, NY (US); Leland Chang, New York, NY (US)

(21) Appl. No.: 18/071,230

(22) Filed: Nov. 29, 2022

(51) Int. Cl. G06F 7/523

(52) U.S. Cl. CPC G06F 7/523

(57) ABSTRACT

An apparatus comprising: a first plurality of inputs representing an activation input vector; a second plurality of inputs representing a weight input vector; an analog multiplier-and-accumulator to generate a first analog voltage representing a first multiply-and-accumulate result for the said first inputs and the second inputs; a voltage multiplier that takes the said first analog voltage and produces a second analog voltage representing, a second multiply-and-accumulate result by multiplying at least one scaling factor to the first analog voltage; an analog to digital converter configured to convert the said second analog voltage multiply-and-accumulate result into a digital signal using a limited-precision operation during a neural network inference operation; and a hardware controller configured to determine the at least one scaling factor based on the first multiply-and-accumulate result, or a software controller configured to determine the at least one scaling factor based on the first multiply-and-accumulate result.

### BACKGROUND

The exemplary embodiments described herein relate generally to machine learning hardware device design and integrated circuit design, and more specifically, to scalable switch capacitor computation cores for accurate and efficient deep learning inference.

### SUMMARY

In one aspect, an apparatus includes: a first plurality of inputs representing an activation input vector; a second plurality of inputs representing a weight input vector; an analog multiplier-and-accumulator to generate a first analog voltage representing a first multiply-and-accumulate result for the said first inputs and the second inputs; a voltage multiplier that takes the said first analog voltage and produces a second analog voltage representing a second multiply-and-accumulate result by multiplying at least one scaling factor to the first analog voltage; an analog to digital converter configured to convert the said second analog voltage multiply-and-accumulate result into a digital signal using a limited-precision operation during a neural network inference operation; and a hardware controller configured to determine the at least one scaling factor based on the first multiply-and-accumulate result, or a software controller configured to determine the at least one scaling factor based on the first multiply-and-accumulate result.

In another aspect, an apparatus includes: a first plurality of inputs representing an original activation input vector; a plurality of voltage multipliers that take the said first plurality of inputs and produce a second plurality of inputs by multiplying at least one scaling factor to voltages of the original activation input vector; a third plurality of inputs representing a weight input vector; an analog multiplier-and-accumulator to generate an analog voltage representing a multiply-and-accumulate result for the said second inputs and the third inputs; an analog to digital converter configured to convert the said analog voltage multiply-and-accumulate result into a digital signal using a limited-precision operation during a neural network inference operation; and a hardware controller configured to determine the at least one scaling factor based on the multiply-and-accumulate result, or a software controller configured to determine the at least one scaling factor based on the multiply-and-accumulate result.

In another aspect, a method includes receiving a first plurality of inputs representing an activation input vector; receiving a second plurality of inputs representing a weight input vector; generating, with an analog multiplier-and-accumulator, an analog voltage representing a multiply-and-accumulate result for the first plurality of inputs and the second plurality of inputs; converting, with an analog to digital converter, the analog voltage multiply-and-accumulate result into a digital signal using a limited-precision operation during an inference operation of a neural network; and determining, during training or calibration of the neural network, at least one scaling factor used to amplify the first plurality of inputs or to amplify the analog voltage multiply-and-accumulate result.

### BRIEF DESCRIPTION OF THE DRAWINGS

The foregoing and other aspects of exemplary embodiments are made more evident in the following Detailed Description, when read in conjunction with the attached Drawing Figures, wherein:

FIG. 1 depicts a high-level diagram of a mixed-signal switched capacitor multiplier and accumulator;

FIG. 2 depicts a 16 bit accumulator with severe truncation and an 8 bit accumulator;

FIG. 3 depicts a 16 bit accumulator with scaled distribution of values as input to the ADC, and an 8 bit accumulator;

FIG. 4 depicts handling of scalars for a DNN layer;

FIG. 5 is a flow diagram of an auto-search algorithm for determining an optimal scalar;

FIG. 6 is an example software implementation of an auto-scale algorithm, based on the examples described herein;

FIG. 7 depicts an example implementation of a truncation portion of the auto-scale algorithm described herein;

FIG. 8 depicts an example implementation of a portion of the auto-scale algorithm described herein;

FIG. 9A depicts using an amplifier to scale analog signals in switch capacitor hardware;

FIG. 9B depicts using an input multiplier to scale analog signals in switch capacitor hardware;

FIG. 9C depicts charge sharing to scale analog signals in switch capacitor hardware;

FIG. 10 is a circuit diagram for machine learning hardware;

FIG. 11 is a circuit diagram showing a first embodiment of the examples described herein, with amplification of a multiply-and-accumulate result;

FIG. 12 is a circuit diagram of an embodiment of a sum multiplier using switched capacitors;

FIG. 13 is a circuit diagram showing a second embodiment of the examples described herein, with voltage multipliers at the inputs;

FIG. 14 is a circuit diagram of one embodiment of an input multiplier using a level shifter;

FIG. 15 is a circuit diagram showing the first operation phase of a third embodiment of the examples described herein, implementing voltage sampling with a sum multiplier with capacitors connected in parallel;

FIG. 16 is a circuit diagram showing the second operation phase of the third embodiment of the examples described herein, implementing voltage multiplication with a sum multiplier with capacitors reconfigured to be connected in series;

FIG. 17 is a graph showing NN accuracy performance results, comparing the results with and without implementation of the examples described herein;

FIG. 18 is another graph showing NN accuracy performance results;

FIG. 19 is a graph showing quantization aware training convergence without implementation of the examples described herein;

FIG. 20 is a graph showing a comparison of performance results with and without auto-search scaling;

FIG. 21 is a logic flow diagram to implement a method, based on the examples described herein; and

FIG. 22 is a logic flow diagram to implement a method, based on the examples described herein.

### DETAILED DESCRIPTION

The term “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

A low-precision ADC (<16 bits) is needed to limit the ADC energy consumption and realize a highly energy efficient switched capacitor computation core. Such low-precision ADC truncates the analog output of the switched capacitor MACC when it falls outside a pre-defined voltage range and provides a digital output expressed by fewer than 16 bits. This truncation operation reduces the precision of the analog MACC output and may result in decreased accuracy during neural network inference. Therefore, what is needed is hardware and software to enable performing ADC truncation without degrading neural network inference accuracy.

Accordingly, described herein is a method to determine an optimal integer scalar for ADC truncation via an auto-search algorithm (“auto-scale”) and related hardware implementation. Disclosed herein are the process steps to determine at least one optimal integer scalar, how to handle layer-wise MACC, and how to deal with overflow. Described herein are three options to incorporate the as-determined scalars into hardware, by modifying the analog signals during switched-capacitor analog computation: (1) amplifier (at the input or at the output), (2) input multiplier, and (3) charge sharing.

A challenge addressed by the examples described herein is that SC-PT core ADC truncation impacts accuracy. The examples described herein fully utilize SC-PT core ADC precision. MACC input or output is scaled up by an integer factor, for which there are various implementation options.

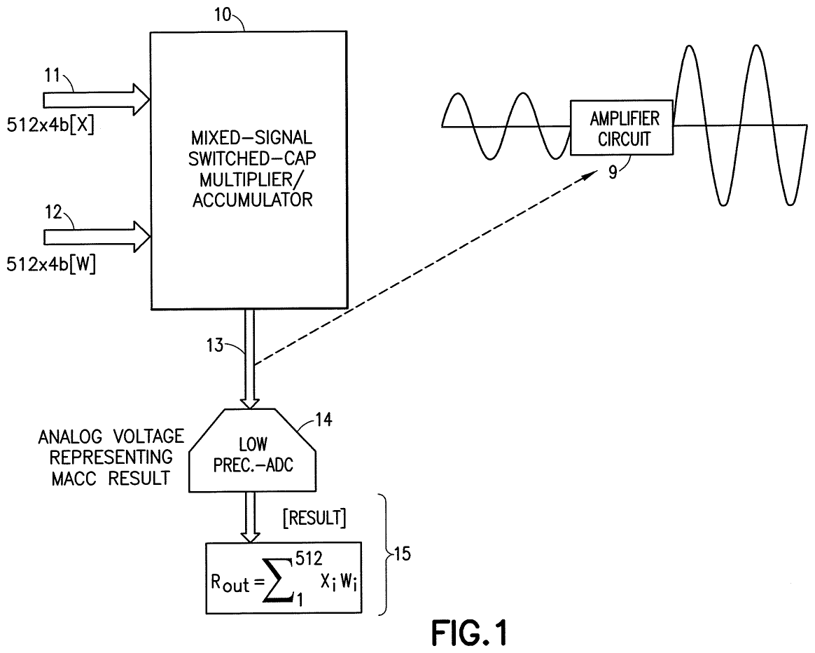

FIG. 1 depicts a high-level diagram of a mixed-signal switched capacitor multiplier and accumulator (10). The mixed-signal switched capacitor multiplier and accumulator (10) takes as input an input vector comprising 512 values of 4 bits each, or 512x 4b [X] (11), and a weight vector comprising 512 values of 4 bits each, or 512x 4b [W] (12). The input 11 may include an added shift. An output (13) from the mixed-signal switched capacitor multiplier and accumulator (10) is provided to a low precision analog to digital converter 14. The low precision analog to digital converter 14 may be an 8 bit ADC. For example, the ADC being 8 bits is an illustrative example, as the size of the ADC may be of a size corresponding to other limited or low precision. The output 13 of the mixed-signal switched capacitor multiplier and accumulator (10) is an analog voltage representing a MACC result. The result (15) (e.g. 8 bits) of the low precision analog to digital converter is of the form Rₒᵤₜ=Σ₁⁵¹²(XᵢWᵢ), where R corresponds to result, X is the input vector comprising N values of 4 bits each (in this example, N=512), W is the weight vector comprising N values of 4 bits each (in this example, N=512), and the i subscript identifies the accumulation over the N products, such that each i element of X and W are first multiplied, then all N products are summed together. This operation as a whole is what is called MACC (multiply-and-accumulate).

The output (13) may be based on several factors, such as application to different DNN layers such as linear layers and BMM layers. The linear layers may be based on scale output or adding a number in activation. The BMM layers may be based on scale output.

The mixed-signal switched capacitor multiplier and accumulator (10) may be coupled to an amplifier circuit (9) having an amplifier that supports different amplification rates. In particular, an amplifier may be added to scale analog signals with software defined amplification rates.

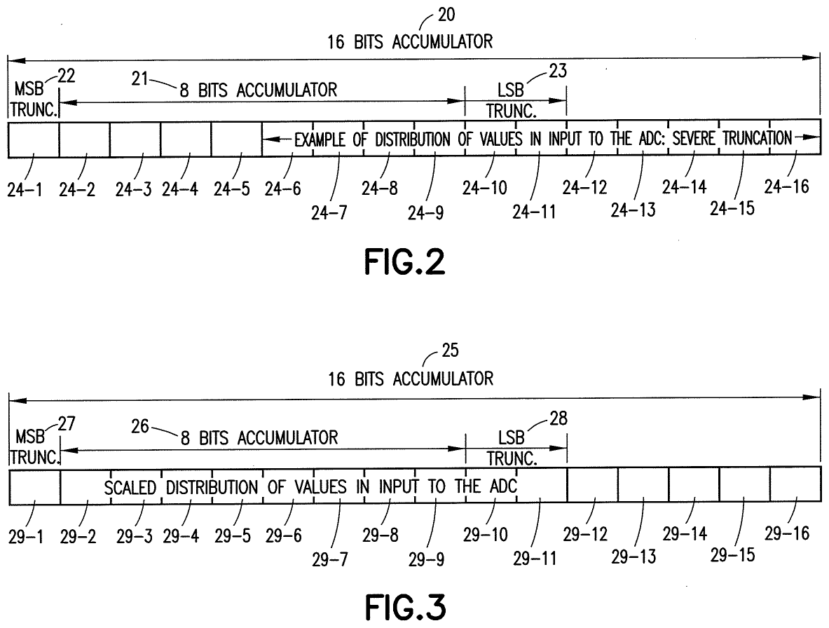

FIG. 2 depicts a 16 bit accumulator (20) and an 8 bit accumulator (21). As shown in FIG. 2, the 16 bit accumulator 20 includes bits 24-1, 24-2, 24-3, 24-4, 24-5, 24-6, 24-7, 24-8, 24-9, 24-10, 24-11, 24-12, 24-13, 24-14, 24-15, and 24-16. The 8 bit accumulator 21 includes bits 24-2, 24-3, 24-4, 24-5, 24-6, 24-7, 24-8, and 24-9. In FIG. 2, an example of distribution of values in input to the ADC with severe truncation is shown by bits 24-6, 24-7, 24-8, 24-9, 24-10, 24-11, 24-12, 24-13, 24-14, 24-15, and 24-16.

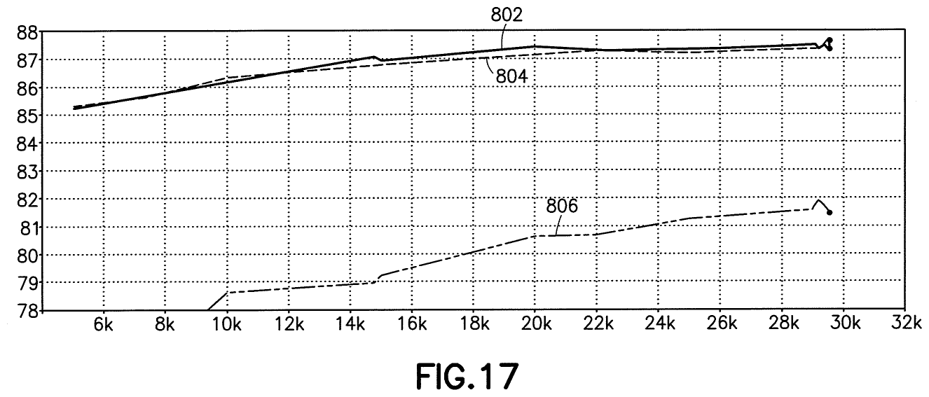

FIG. 2 illustrates a 16 bit accumulator (20) without implementation of the examples described herein. The bits indicated as 24-6, 24-7, 24-8, 24-9, 24-10, 24-11, 24-12, 24-13, 24-14, 24-15, and 24-16 show a hypothetical extent (range) of the values of a MACC output (where MACC corresponds to a multiply-and-accumulate operation). Two truncation thresholds (MSB trunc. 22 and LSB trunc. 23) determine the conversion from analog voltage to digital representation of the MACC output, following processing by a low-precision ADC (8-bit ADC, in this example). In this scenario, many bits are truncated (i.e., MACC output values are approximated by a highly truncated representation, following digital conversion). This results in high MACC errors compared to a non-approximated MACC, and poor neural network accuracy. As an example, refer to the experimental results in FIG. 17, where 7 bits LSB truncation (plot 806) gives −6.9% F1 performance (F1 is a measure of accuracy) compared to the non-truncated results obtained with a 16-bit ADC (plot 804).

FIG. 3 depicts a 16 bit accumulator (25) and an 8 bit accumulator (26). Depicted is MSB truncation threshold 27 and LSB truncation threshold 28 that determine the conversion from analog voltage to digital representation of the MACC output, following processing by a low-precision ADC. The 16 bit accumulator (25) includes bits 29-1, 29-2, 29-3, 29-4, 29-5, 29-6, 29-7, 29-8, 29-9, 29-10, 29-11, 29-12, 29-13, 29-14, 29-15, and 29-16. The 8 bit accumulator 26 includes bits 29-2, 29-3, 29-4, 29-5, 29-6, 29-7, 29-8, and 29-9. Scaled distribution of values with input to the ADC is shown by bits 29-2, 29-3, 29-4, 29-5, 29-6, 29-7, 29-8, 29-9, 29-10, and 29-11.

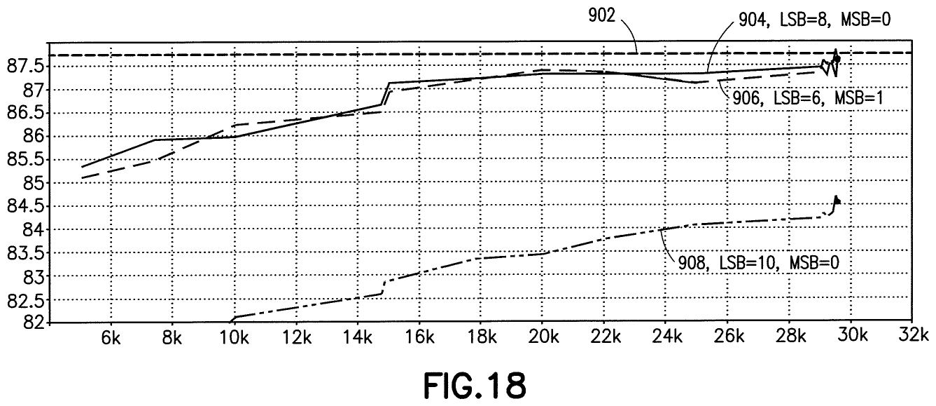

FIG. 3 illustrates the 16 bit accumulator (25) with implementation of the examples described herein. In FIG. 3, the MACC values are scaled up by an integer factor, then a truncation is performed by the analog to digital conversion of the low-precision ADC, then the results are shifted back down. This improves performance dramatically, as shown in FIG. 17 and FIG. 18. For example, 8 bits of LSB truncation (plot 802) give just −0.1% F1 performance (a minor degradation), compared to the non-truncated result obtained with a 16-bit ADC (plot 804).

The output distribution varies at each DNN layer. Fixed ADC truncation causes severe degradation. ADC power saving is mainly from LSB truncation. It is favorable to truncate LSB instead of MSB, to for example save ADC power.

The shaded bits 24-6, 24-7, 24-8, 24-9, 24-10, 24-11, 24-12, 24-13, 24-14, 24-15, and 24-16 in FIG. 2, and the shaded bits 29-2, 29-3, 29-4, 29-5, 29-6, 29-7, 29-8, 29-9, 29-10, and 29-11 in FIG. 3 represent the bits required to cover a hypothetical distribution of inputs to the ADC, or equivalently, the output of the MACC (label 13 in FIG. 1). For example, an input to the ADC may have low values and occupy the lowest bits (24-6 to 24-16 in FIG. 2). The other bits are not utilized (24-1 to 24-5 in FIG. 2). This results in poor performance when the LSB bits are truncated because several used bits (of the shaded bits 24-6, 24-7, 24-8, 24-9, 24-10, 24-11, 24-12, 24-13, 24-14, 24-15, and 24-16 in FIG. 2) are truncated away.

The “scaled” in FIG. 3 corresponds to amplification, where each value of the input to the ADC is multiplied, or scaled up, by an amplification factor. There may be distributions of input to the ADC (or MACC outputs, they are the same). If many MACC operations are performed with different inputs, the MACC output is different for each individual operation performed. Each distribution represents a hypothetical set of MACC outputs, either amplified or not.

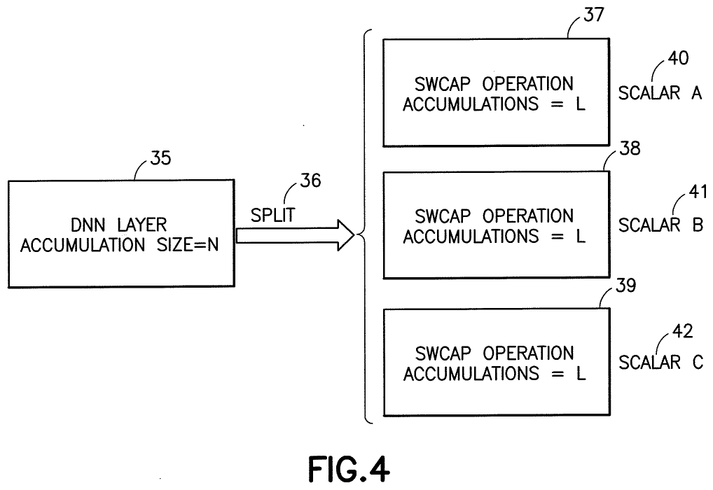

FIG. 4 depicts general handling of scalars for a DNN layer. A DNN layer 35 having an accumulation size of N (e.g. N being an integer) is split 36 into an swcap operation 37 having L accumulations (e.g. L being an integer), an swcap operation 38 having L accumulations, and an swcap operation 39 having L accumulations. The swcap operation 37 is associated with scalar A (40), the swcap operation 38 is associated with scalar B (41), and the swcap operation 39 is associated with scalar C (42).

A swcap operation (37, 38, 39) performs an atomic MACC in the swcap core. Accumulation length L is fixed by the HW (for example, L=512).

A GEMM performed by a DNN layer may require a number of accumulations N>L. If so, the MACC layer is split into several swcap atomic MACCs.

Each swcap operation (37, 38, 39) can have its own independent integer (INT) scalar (40, 41, 42), which is associated to the corresponding swcap operation (37, 38, 39) during compiling.

Alternatively, all separate swcap MACC scalars (40, 41, 42) can be merged into a single layer-wise scalar (for example, selecting the minimum across all scalars), which is shared by all swcap MACC operations (37, 38, 39) in a given layer.

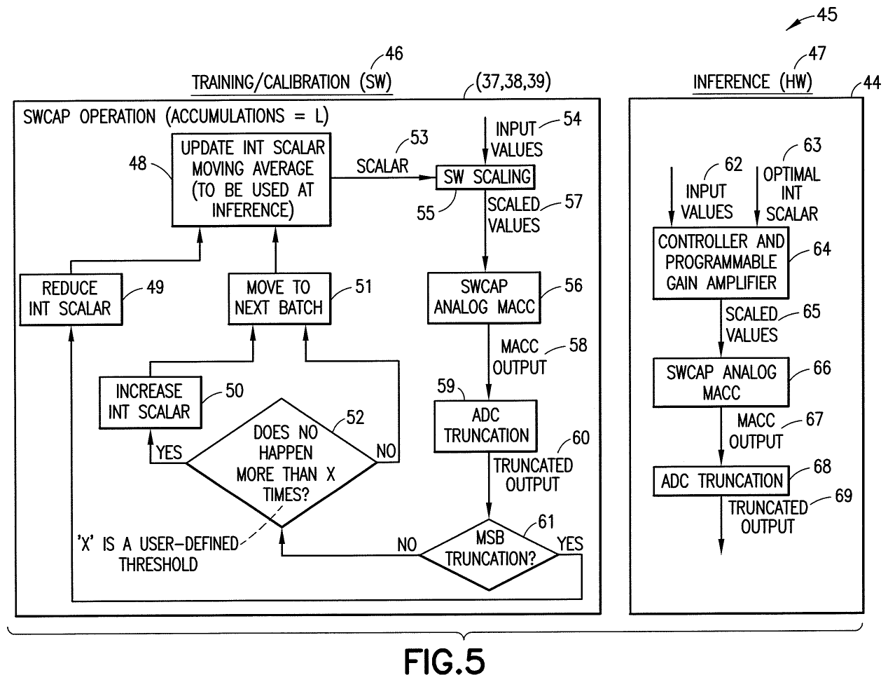

FIG. 5 is a flow diagram of an auto-search algorithm 45 for determining an optimal scalar. The “auto-search” algorithm may also be referred to as an “auto-scale” algorithm. The algorithm 45 automatically searches for the optimal scaling/amplification factor.

The algorithm 45 includes a training/calibration (SW) portion 46 and an inference (HW) portion 47. A scalar 53 is provided to software scaling 55, which software scaling 55 also receives input values 54. The scalar 53 is a user-provided initialization value or the result of the previous loop of the auto-search algorithm for training 46. Software scaling 55 generates scaled values 57, which are provided to swcap analog MACC 56. The swcap analog MACC 56 generates MACC output 58 that is provided to ADC truncation 59.

ADC truncation 59 generates truncated output 60. At 61, it is determined, based on the truncated output 60, whether there is to be MSB truncation. If there is MSB truncation at 61 (e.g. “YES”), the method transitions to 49. If there is no MSB truncation at 61 (e.g. “NO”), the method transitions to 52. At 49, the INT scalar is reduced, and the method transitions to 48. At 52, a determination is made as to the number of times MSB truncation at 61 is determined not to occur. For example, at 52 a determination is made as to whether “NO” is determined at 61 to have occurred more than ‘X’ times, where ‘X’ is a user-defined threshold. If at 52 it is determined that a ‘NO’ determination at 61 has happened more than ‘X’ times, (e.g. “YES”), the method transitions to 50. If at 52 it is determined that a ‘NO’ determination at 61 has not happened more than ‘X’ times, (e.g. “NO”), the method transitions to 51. At 50, the INT scalar is increased, and from 50 the method transitions to 51. At 51, the method moves to the next batch, and from 51 the method transitions to 48. At 48, an INT scalar moving average is updated, which INT scalar moving average is to be used during inference.

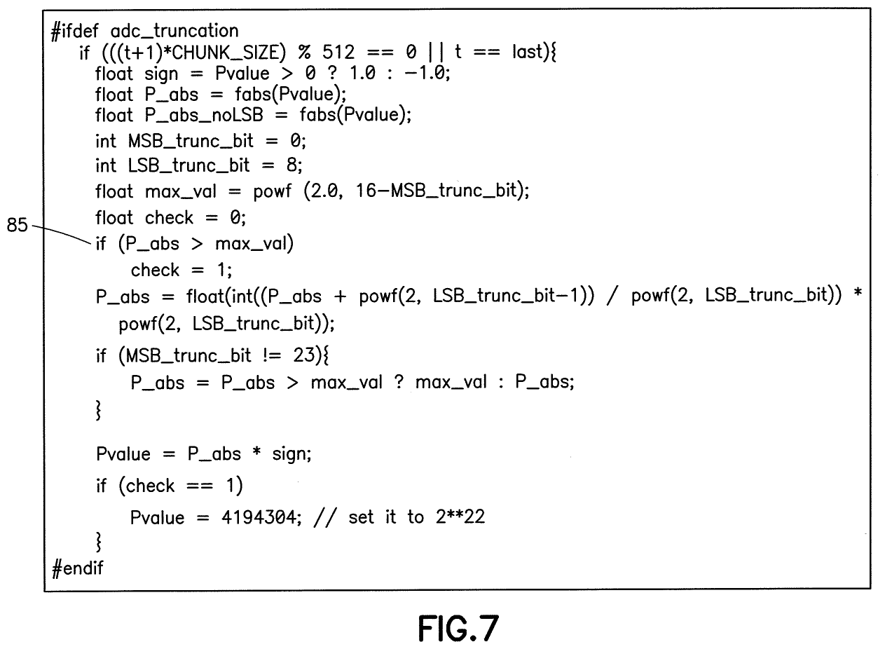

Thus, in case of overflow during training/calibration time (output*scalar>threshold), the method comprises reducing the scalar (49) and redoing the iteration, with or without an update to the NN parameters. If MSB truncation has occurred (61), then a maximum threshold has been exceeded and the batch is repeated with lower amplification at the next loop iteration. Refer to item 85 of FIG. 7, or “if (P_abs>max_val)”.

During inference 47 with inference hardware 44, input values 62 and an optimal INT scalar 63 are provided to controller and programmable gain amplifier 64. The optimal scalar 63 used at inference 47 is the result of the determination of the INT scalar moving average determined at 48 during training 46. The moving average determined at 48 is truncated in order to determine the scalar 63 to be used at inference 47. The controller and programmable gain amplifier 64 generates scaled values 65, which scaled values 65 are provided as input to swcap analog MACC 66. The swcap analog MACC 66 generates MACC output 67, which MACC output 67 is provided as input to ADC truncation 68. ADC truncation 68 generates truncated output 69.

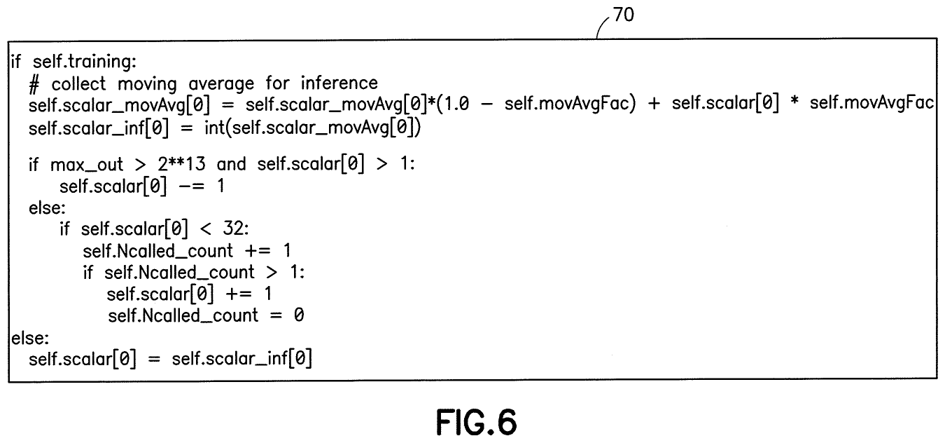

FIG. 6 is an example software implementation 70 of an auto-scale algorithm, based on the examples described herein.

The software 70 decides the INT scalar value for each layer (or atomic swcap operation) during training and/or calibration (either QAT or PTQ). The scalar is increased by 1 if the GEMM output does not exceed a pre-selected ADC limit (e.g. max=32). If the GEMM output exceeds the threshold (the pre-selected ADC limit), the scalar is decreased by 1. The optimal scalar to be used at inference is a static value, determined as the moving average, truncated to an integer, of the training scalars. A suitable static scalar is found for DNN inference in ADC truncation.

FIG. 7 depicts an example implementation of a truncation portion of the auto-scale algorithm described herein.

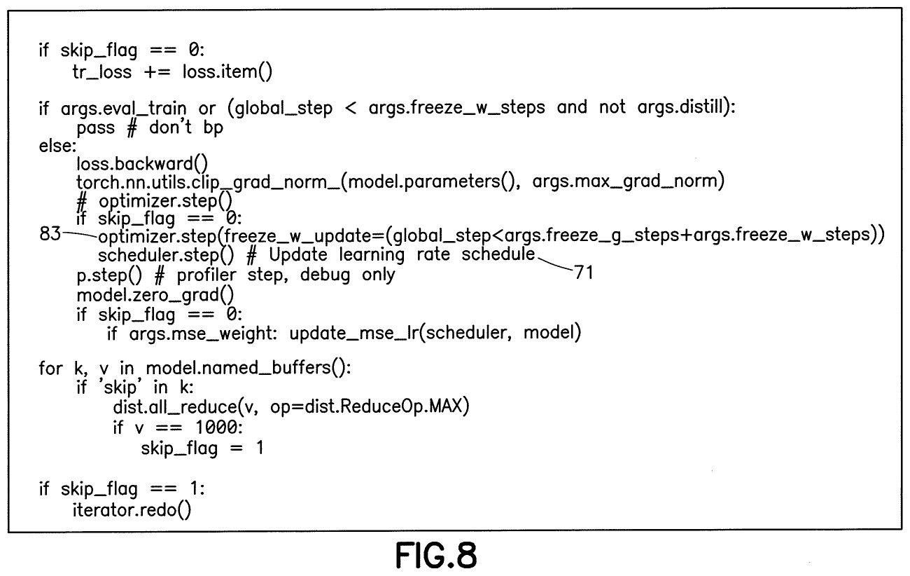

FIG. 8 depicts an example Python implementation of a portion of the auto-scale algorithm described herein. One or more parameters of a neural network and a learning rate (71) are updated within the portion shown in FIG. 8, if overflow did not occur during the processing of a batch. Conversely, if overflow occurred during the processing of a batch, the batch is processed again using lower amplification. The update to the one or more parameters of the neural network refers to item 83, or the line optimizer.step(freeze_w_update=(global_step<args.freeze_g_steps+args.freeze_w_steps)). A neural network process flow includes sending a batch of examples through the network, obtaining output and gradients, updating parameters using gradients, updating the learning rate according to a schedule, and processing a next batch. After processing a batch there are 2 options: 1) if no overflow: move to next batch, or 2) if overflow: repeat the same batch but use lower amplification (see FIG. 5, steps 49 and 51).

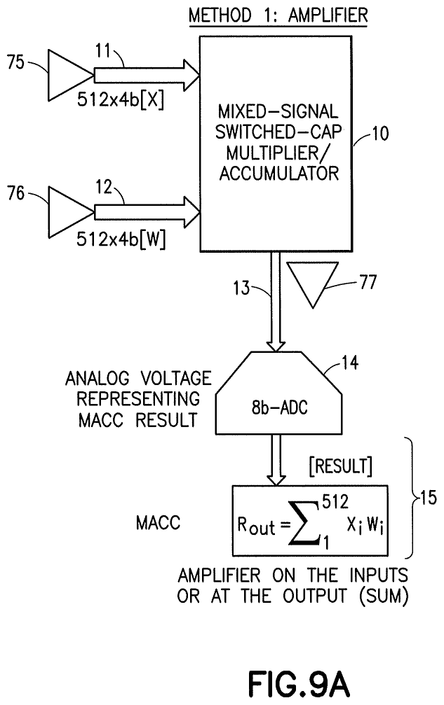

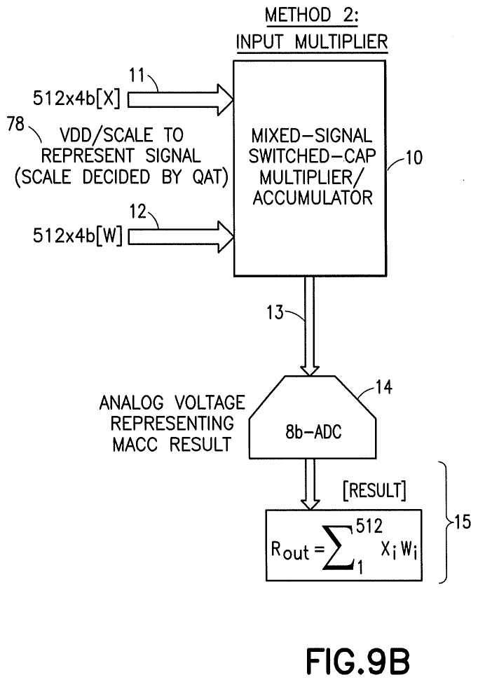

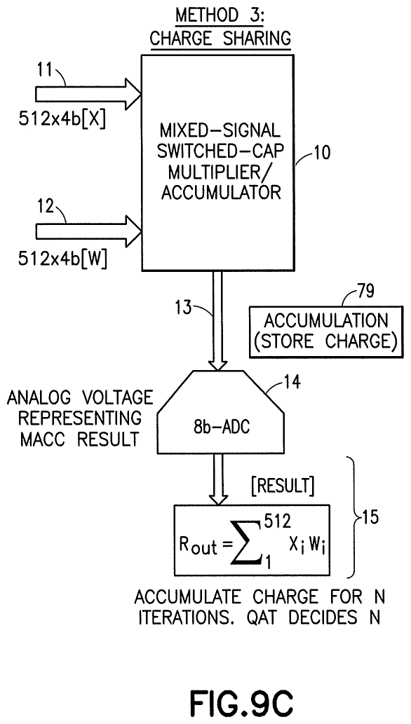

FIG. 9A, FIG. 9B, and FIG. 9C each depicts an option to scale analog signals in the swcap hardware.

FIG. 9A depicts using an amplifier to scale analog signals in switch capacitor hardware. In particular, there is an amplifier (75, 76) on the inputs, such that amplifier 75 is applied to input 11 and/or amplifier 76 is applied to input 12, and/or there is an amplifier (77) at the output 13.

FIG. 9B depicts using an input multiplier (78) to scale analog signals in the switch capacitor hardware. The input multiplier 78 may include a Vdd/scale to represent the signal, where the scale is decided by QAT. The input multiplier 78 may be applied to either input 11 or input 12.

FIG. 9C depicts charge sharing to scale analog signals in switch capacitor hardware. There is an accumulator or store charge (79) for N iterations, where QAT decides N.

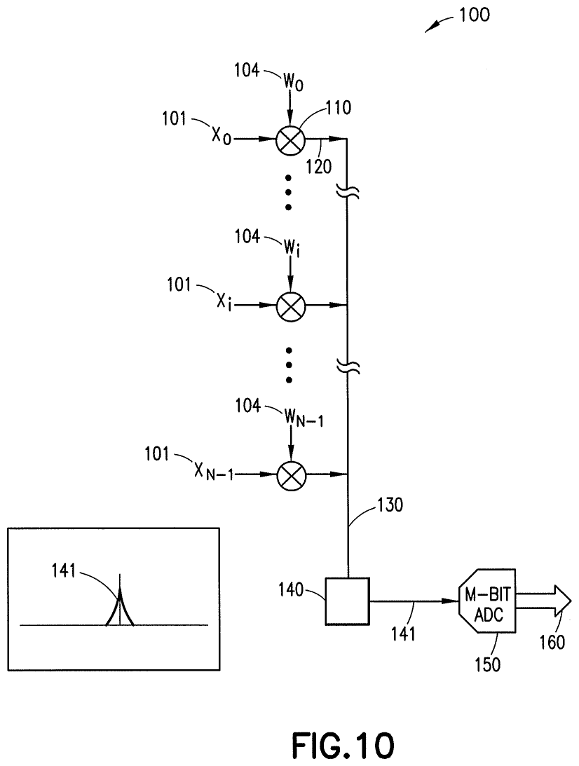

FIG. 10 is a circuit diagram of a circuit 100 for machine learning hardware. The circuit 100 includes N activation inputs 101 (K-bits), N weights 104 (either from local storage or external inputs) (K-bits), a multiplier 110 (digital input, analog output), multiplier output 120—current or charge, summing bit line 130, current or charge to voltage converter 140 (e.g. resistor, transimpedance amplifier, or capacitor), summed voltage 141, AD converter 150, and digital output 160 (M-bit).

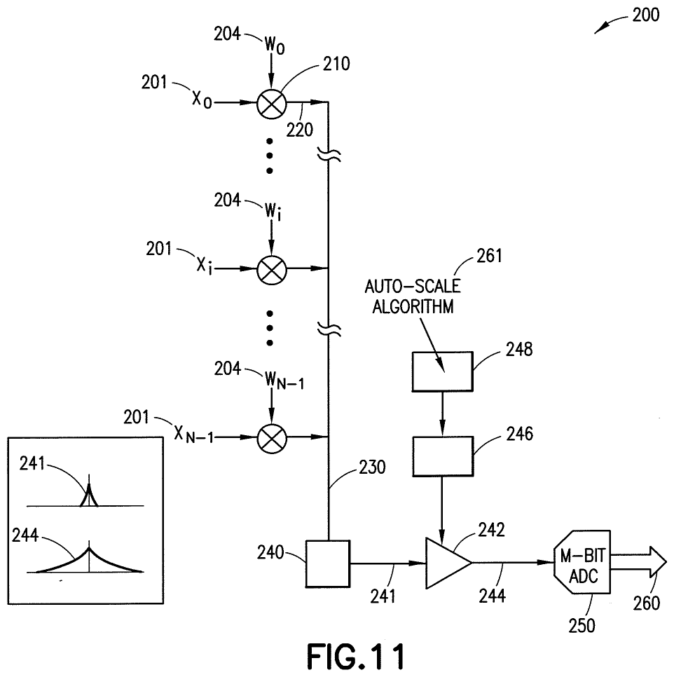

FIG. 11 is a circuit diagram of a circuit 200 showing a first embodiment of the examples described herein, with amplification of a multiply-and-accumulate result. In circuit 200, there is a multiplier at the sum. Circuit 200 includes N activation inputs 201 (K-bits), N weights 204 (either from local storage or external inputs) (K-bits), multiplier 210 (digital input, analog output), multiplier output 220—current or charge, summing bit line 230, current or charge to voltage converter 240 (e.g. resistor, transimpedance amplifier, or capacitor), summed voltage 241, programmable gain amplifier 242, amplified voltage 244, amplifier gain controller 246, computer program/method 248 to determine the optimal gain setting, AD converter 250, and digital output 260 (M-bit). Computer program 248 includes the auto-scale algorithm 261.

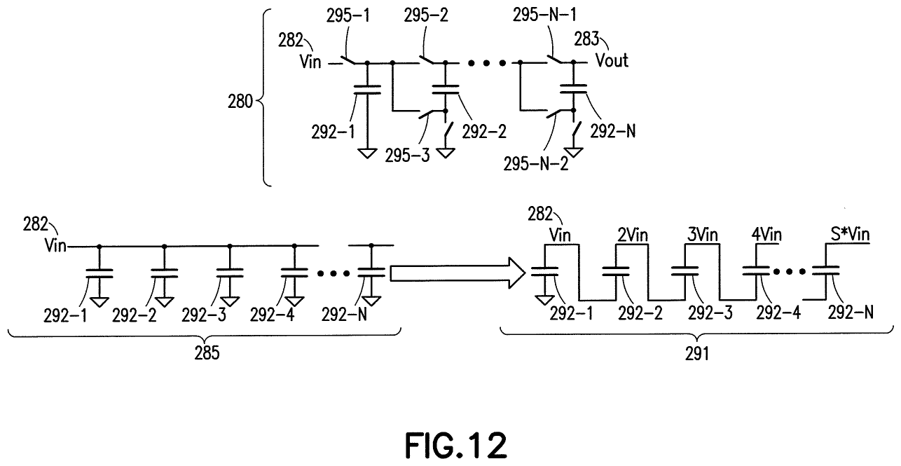

FIG. 12 is a circuit diagram of one embodiment of a sum multiplier 280 using switched capacitors. The sum multiplier 280 is an example implementation of the programmable gain amplifier 242 shown in FIG. 11. The sum multiplier 280 is composed of N capacitors to implement the multiplication factor of ‘N’. Shown are capacitors 292-1, 292-2, 292-3, 292-4, and 292-N.

Each capacitor can be connected in two different ways—parallel and serial. First, all capacitors are connected in the parallel manner (285). The voltage input (282) is sampled by all the capacitors simultaneously. The voltage across each capacitor is the same to the voltage input (282). Then if those capacitors are configured by one or more of the switches (295-1, 295-2, 295-3, 295-N-1, 295-N-2) to be serial (291), then each of the voltages across the capacitors are stacked up, so that the final output voltage (283) becomes N times the voltage input (282), hence achieving the sum multiplier 280. When the output is tapped to an intermediate node, for example output of a K'th capacitor, then the output voltage become K times input voltage (refer to 2Vin, 3Vin, 4Vin, and S*Vin). As K can be anywhere in between 1 and N, the circuit has a programmable multiplication factor in between 1 and N.

In FIG. 12, when the switches are up (connecting the top node of n'th capacitor to the top node of n+1′th capacitor), then the capacitors are parallel. When the switches are down (connecting the top node of n'th capacitor to the bottom node of n+1′th capacitor), then the capacitors are serial.

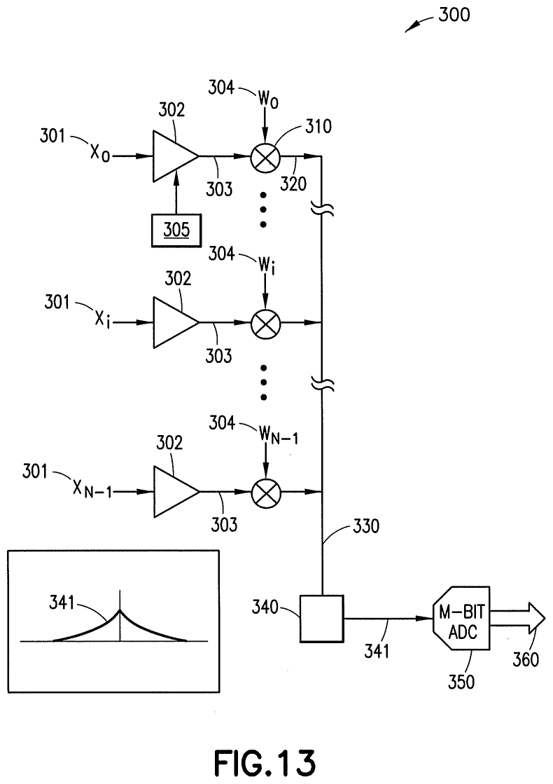

FIG. 13 is a circuit diagram of a circuit 300 showing a second embodiment of the examples described herein, with voltage multipliers at the inputs. In circuit 300, there is a multiplier at the input. Circuit 300 includes N activation inputs 301 (K-bits) [range: 0˜V), a voltage multiplier 302, multiplied activation inputs 303 [range: 0˜S*V] (S: scaling factor), N weights 304 (either from local storage or external inputs) (K-bits), a voltage multiplier controller 305, multiplier 310 (digital input, analog output), multiplier output 320—current or charge, summing bit line 330, current or charge to voltage converter 340 (e.g. resistor, transimpedance amplifier, or capacitor), summed voltage 341, AD converter 350, and digital output 360 (M-bit).

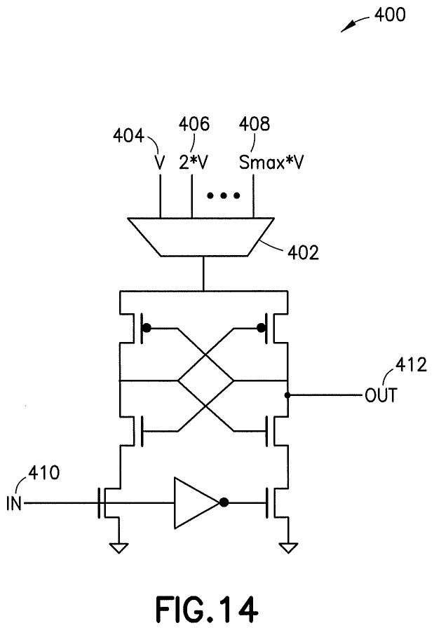

FIG. 14 is a circuit diagram of one embodiment of an input multiplier 400 using a level shifter. The input multiplier 400 is an example implementation of the current or charge to voltage converter 340 shown in FIG. 13. When input voltage 410 is zero, then the output voltage 412 is zero. When input voltage 410 is V, then the output voltage 412 depends on the power supply voltage of the circuit that is the output voltage of the multiplexer 402. For example, when the output of the multiplexer 402 is K*V, then the output voltage 412 is also K*V. Therefore, output voltage 412 is the input voltage 410 multiplied by K. As K is in between 1 through Smax, the input multiplier 400 can have the multiplication factor of 1 through Smax. The input multiplier 400 includes a multiplexer 402 that selects an input from among V 404, 2*V 406, up to Smax*V 408.

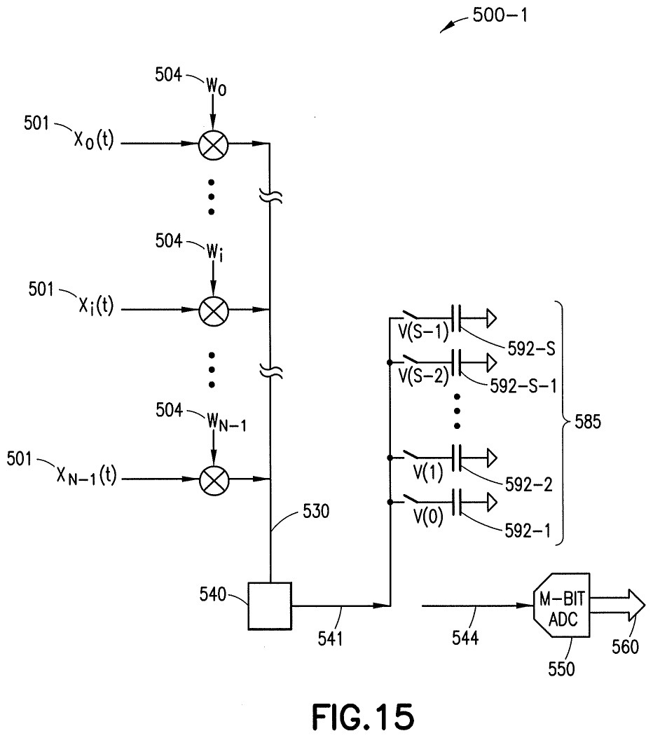

FIG. 15 is a circuit diagram of a circuit 500-1 showing the first operation phase of a third embodiment of the examples described herein, implementing voltage sampling with a sum multiplier with capacitors connected in parallel. In FIG. 15, there is amplification of the multiply-and-accumulate result 541 using a sum multiplier. FIG. 15 corresponds to the circuit state 285 of FIG. 12 (refer to item 585).

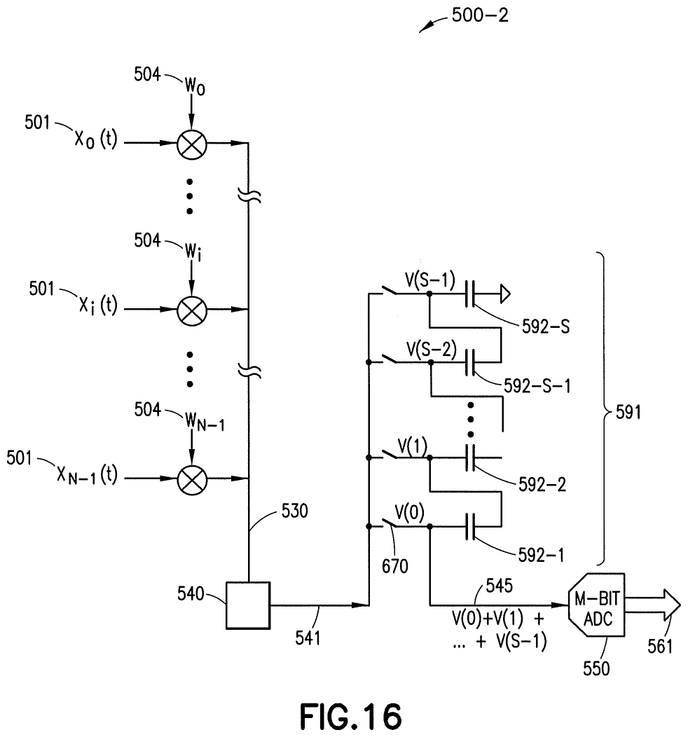

FIG. 16 is a circuit diagram of a circuit 500-2 showing the second operation phase of the third embodiment of the examples described herein, implementing voltage multiplication with a sum multiplier with capacitors reconfigured to be connected in series. In FIG. 16, there is amplification of the multiply-and-accumulate result 541 using a sum multiplier. FIG. 16 corresponds to the circuit state 291 of FIG. 12 (refer to item 591).

Referring to FIG. 15 and FIG. 16, given S input vectors, where t=0 . . . S-1, V(t) samples the sum for the t'th input vector (X(t)). The circuits (500-1, 500-2) include N activation inputs 501 (K-bits), N weights 504 (either from local storage or external inputs (K-bits), summing bit line 530, current or charge to voltage converter 540 (e.g. resistor, transimpedance amplifier, or capacitor), summed voltage 541, capacitors 592-1, 592-2, 592-S-1, and 592-S, and M-bit ADC converter 550. Circuit 500-1 includes amplified voltage 544 generated from the configuration 585 of the sum multiplier, and results in digital output 560 following analog to digital conversion using ADC 550. Circuit 500-2 includes amplified voltage 545 generated from the configuration 591 of the sum multiplier, and results in digital output 561 following analog to digital conversion using ADC 550.

FIG. 17 is a graph showing NN accuracy on an evaluation set, during training of BERT-base INT4 model. FIG. 17 compares results of a reference run (plot 804) against results without implementation of the examples described herein (plot 806), and results with the examples described herein (plot 802). The y-axis is F1. The x-axis is training iterations. Plot 804 correspond to accuracy results without ADC truncation. Plot 802 corresponds to accuracy results when auto-scale is implemented and 7 bits of ADC LSB truncation are used. Plot 806 corresponds to accuracy results when auto-scale is not implemented and 7 bits of ADC LSB truncation are used. Plot 802 has a peak F1 value of 87.5%, plot 804 has a peak F1 value of 87.5%, and plot 806 has a peak F1 value of 81.8%. Therefore, with the examples described herein, a low-precision ADC (with truncation) can be used to match accuracy performance of a high-precision (no truncation) ADC.

FIG. 18 is another graph showing NN accuracy on an evaluation set, during the training of BERT-base INT4 model. The y-axis is F1, and the x-axis is training iterations. Plot 902 shows a fixed 87.7% F1 value, plot 904 corresponds to LSB=8, MSB=0, plot 906 corresponds to LSB=6, MSB=1, and plot 908 corresponds to LSB=10, MSB=0. When using LSB=6, MSB=1 (plot 906), the results are close to the int4 baseline of 87.7% (plot 902).

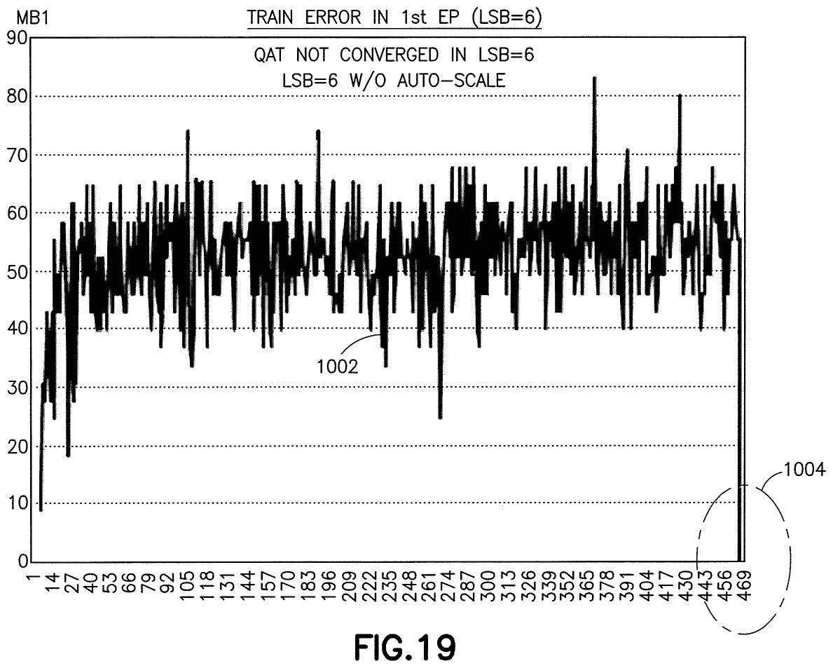

FIG. 19 is a graph showing quantization aware training convergence for the MobileNet-v1 (MB1) model. Plot 1002 corresponds to LSB=6 truncation without auto-search. Without auto-search, MB1 QAT cannot converge using LSB=6 truncation. The y-axis is training error, and the x-axis is training epochs. FIG. 19 shows convergence area 1004.

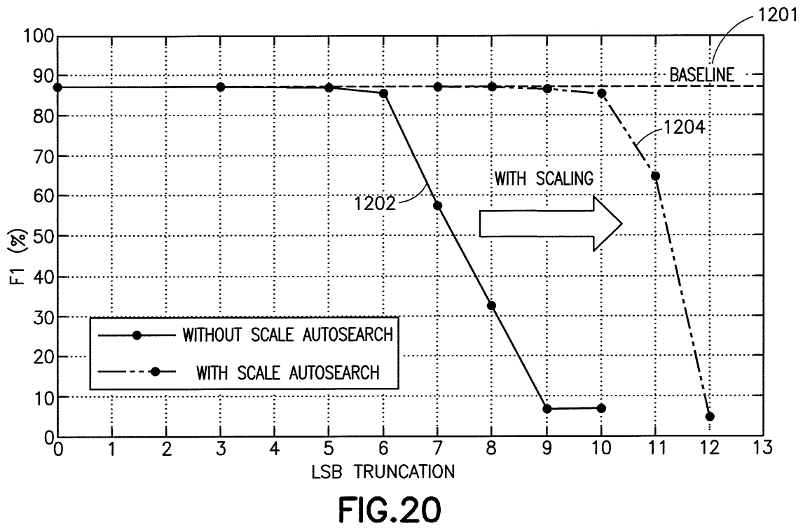

FIG. 20 is a graph showing a comparison of performance results with and without auto-search scaling for post-training quantization of a BERT-base INT8 model. Plot 1202 corresponds to implementation without auto-search scaling, and plot 1204 corresponds to implementation with auto-search scaling. Plot 1201 corresponds to a baseline F1 value. Amplification up to 32 times (32x) enables iso-accuracy for more aggressive LSB truncation.

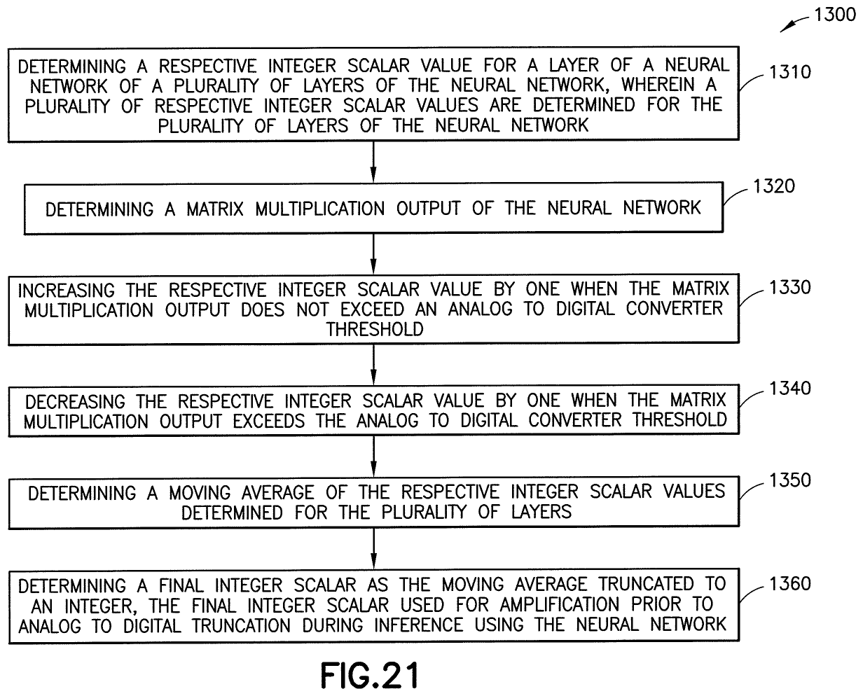

FIG. 21 is a logic flow diagram to implement a method 1300, based on the examples described herein. At 1310, the method includes determining a respective integer scalar value for a layer of a neural network of a plurality of layers of the neural network, wherein a plurality of respective integer scalar values are determined for the plurality of layers of the neural network. At 1320, the method includes determining a matrix multiplication output of the neural network. At 1330, the method includes increasing the respective integer scalar value by one when the matrix multiplication output does not exceed an analog to digital converter threshold. At 1340, the method includes decreasing the respective integer scalar value by one when the matrix multiplication output exceeds the analog to digital converter threshold. At 1350, the method includes determining a moving average of the respective integer scalar values determined for the plurality of layers. At 1360, the method includes determining a final integer scalar as the moving average truncated to an integer, the final integer scalar used for amplification prior to analog to digital truncation during inference using the neural network.

The method 1300 may further include determining the integer scalar value for the layer of the neural network during training of the neural network, wherein the training comprises quantization aware training.

The method 1300 may further include determining the integer scalar value for the layer of the neural network during calibration of the neural network, wherein the calibration comprises post-training quantization.

The method 1300 may further include wherein the layer of the neural network comprises a switch capacitor operation.

The method 1300 may further include reducing the scalar and redoing an iteration of training the neural network or calibrating the neural network, with or without an update to at least one parameter of the neural network, in response to there being overflow during the training or calibration.

The method 1300 may further include determining a first value associated with most significant bit truncation; determining a threshold based on a second value associated with a bit accumulator and the first value associated with most significant bit truncation; and determining the overflow as when a third value associated with the matrix multiplication output exceeds the threshold. For example after amplification, when the MACC output is 14 bits, the accumulator is 16, and the MSB truncation is 3 bits, then the threshold is 16−3=13 and the MACC output of 14 bits exceeds the threshold of 13 bits. Thus, the method 1300 may further include wherein the threshold is determined as the first value associated with most significant bit truncation subtracted from the second value associated with the bit accumulator, and wherein the first value is a first number of bits, the second value is a second number of bits, and the third value is a third number of bits.

The method 1300 may further include determining whether to apply a most significant bit truncation to the matrix multiplication output; reducing the respective integer scalar value, in response to determining to apply the most significant bit truncation to the matrix multiplication output; and increasing the respective integer scalar value, in response to not determining to apply the most significant bit truncation to the matrix multiplication output more than a threshold number of times.

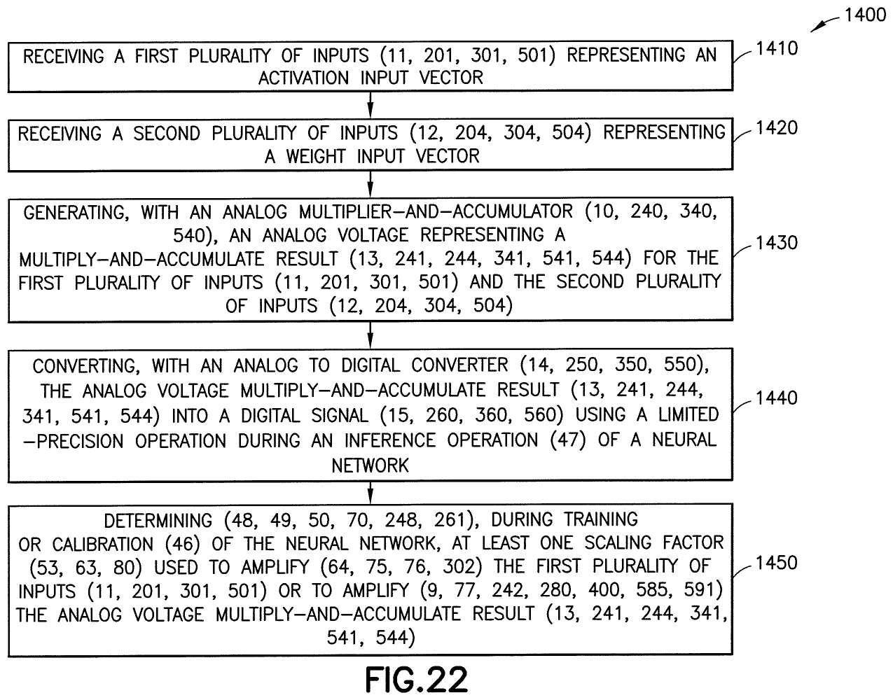

FIG. 22 is a logic flow diagram to implement a method 1400, based on the examples described herein. At 1410, the method includes receiving a first plurality of inputs (11, 201, 301, 501) representing an activation input vector. At 1420, the method includes receiving a second plurality of inputs (12, 204, 304, 504) representing a weight input vector. At 1430, the method includes generating, with an analog multiplier-and-accumulator (10, 240, 340, 540), an analog voltage representing a multiply-and-accumulate result (13, 241, 244, 341, 541, 544) for the first plurality of inputs (11, 201, 301, 501) and the second plurality of inputs (12, 204, 304, 504). At 1440, the method includes converting, with an analog to digital converter (14, 250, 350, 550), the analog voltage multiply-and-accumulate result (13, 241, 244, 341, 541, 544) into a digital signal (15, 260, 360, 560) using a limited-precision operation during an inference operation (47) of a neural network. At 1450, the method includes determining (48, 49, 50, 70, 248, 261), during training or calibration (46) of the neural network, a scaling factor (53, 63, 80) used to amplify (64, 75, 76, 302) the first plurality of inputs (11, 201, 301, 501) or to amplify (9, 77, 242, 280, 400, 585, 591) the analog voltage multiply-and-accumulate result (13, 241, 244, 341, 541, 544).

Referring now to all the Figures, the following examples are disclosed herein.

Example 1. An apparatus including: a first plurality of inputs representing an activation input vector; a second plurality of inputs representing a weight input vector; an analog multiplier-and-accumulator to generate a first analog voltage representing a first multiply-and-accumulate result for the said first inputs and the second inputs; a voltage multiplier that takes the said first analog voltage and produces a second analog voltage representing a second multiply-and-accumulate result by multiplying at least one scaling factor to the first analog voltage; an analog to digital converter configured to convert the said second analog voltage multiply-and-accumulate result into a digital signal using a limited-precision operation during a neural network inference operation; and a hardware controller configured to determine the at least one scaling factor based on the first multiply-and-accumulate result, or a software controller configured to determine the at least one scaling factor based on the first multiply-and-accumulate result.

Example 2. The apparatus of example 1, wherein the at least one scaling factor comprises a plurality of independent scaling factors determined during training of a neural network, one independent scaling factor per switched capacitor operation of a layer of a neural network comprising a plurality of layers.

Example 3. The apparatus of any of examples 1 to 2, wherein the apparatus determines the at least one scaling factor during training of a neural network.

Example 4. The apparatus of example 3, wherein the at least one scaling factor determined during training and used at inference is an integer value.

Example 5. The apparatus of any of examples 1 to 4, further comprising: an accumulation store charge configured to accumulate a charge corresponding to the second analog voltage multiply-and-accumulate result for a number of iterations.

Example 6. The apparatus of any of examples 1 to 5, further comprising: a programmable controller configured to control the voltage multiplier, based on the at least one scaling factor.

Example 7. The apparatus of any of examples 1 to 6, wherein the voltage multiplier comprises a plurality of switched capacitors configured in series or parallel.

Example 8. An apparatus including: a first plurality of inputs representing an original activation input vector; a plurality of voltage multipliers that take the said first plurality of inputs and produce a second plurality of inputs by multiplying at least one scaling factor to voltages of the original activation input vector; a third plurality of inputs representing a weight input vector; an analog multiplier-and-accumulator to generate an analog voltage representing a multiply-and-accumulate result for the said second inputs and the third inputs; an analog to digital converter configured to convert the said analog voltage multiply-and-accumulate result into a digital signal using a limited-precision operation during a neural network inference operation; and a hardware controller configured to determine the at least one scaling factor based on the multiply-and-accumulate result, or a software controller configured to determine the at least one scaling factor based on the multiply-and-accumulate result.

Example 9. The apparatus of example 8, wherein the at least one scaling factor comprises a plurality of independent scaling factors, one independent scaling factor per switched capacitor operation of a layer of a neural network comprising a plurality of layers.

Example 10. The apparatus of example 9, wherein the plurality of independent scaling factors is determined during training of a neural network.

Example 11. The apparatus of any of examples 8 to 10, wherein the apparatus determines the at least one scaling factor during training of a neural network.

Example 12. The apparatus of example 11, wherein the at least one scaling factor determined during training and used at inference is an integer value.

Example 13. The apparatus of any of examples 8 to 12, further comprising: an accumulation store charge configured to accumulate a charge corresponding to the analog voltage multiply-and-accumulate result for a number of iterations.

Example 14. The apparatus of any of examples 8 to 13, further comprising: at least one programmable controller configured to control the plurality of voltage multipliers, based on the at least one scaling factor.

Example 15. A method including: receiving a first plurality of inputs representing an activation input vector; receiving a second plurality of inputs representing a weight input vector; generating, with an analog multiplier-and-accumulator, an analog voltage representing a multiply-and-accumulate result for the first plurality of inputs and the second plurality of inputs; converting, with an analog to digital converter, the analog voltage multiply-and-accumulate result into a digital signal using a limited-precision operation during an inference operation of a neural network; and determining, during training or calibration of the neural network, at least one scaling factor used to amplify the first plurality of inputs or to amplify the analog voltage multiply-and-accumulate result.

Example 16. The method of example 15, further comprising: determining a plurality of independent scaling factors, comprising determining one independent scaling factor per switched capacitor operation of a layer of a neural network comprising a plurality of layers, wherein the at least one scaling factor comprises the plurality of independent scaling factors.

Example 17. The method of any of examples 15 to 16, wherein amplifying the first plurality of inputs comprises producing, with a plurality of voltage multipliers, an amplified first plurality of inputs by multiplying the at least one scaling factor to voltages of the activation input vector, the method further comprising generating, with the analog multiplier-and-accumulator, the analog voltage multiply-and-accumulate result for the amplified first plurality of inputs.

Example 18. The method of any of examples 15 to 17, wherein amplifying the analog voltage comprises producing, with a voltage multiplier, an amplified analog voltage multiply-and-accumulate result by applying the at least one scaling factor to the analog voltage multiply-and-accumulate result, the method further comprising converting, with the analog to digital converter, the amplified analog voltage multiply-and-accumulate result into the digital signal using the limited-precision operation during the inference operation of the neural network.

Example 19. The method of example 18, further comprising: configuring a plurality of switched capacitors of the voltage multiplier in series; or configuring the plurality of switched capacitors of the voltage multiplier in parallel.

Example 20. The method of any of examples 15 to 19, further comprising: accumulating a charge corresponding to the analog voltage multiply-and-accumulate result for a number of iterations.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memory(ies) as described herein may be implemented using any suitable data storage technology, such as semiconductor based memory devices, flash memory, magnetic memory devices and systems, optical memory devices and systems, non-transitory memory, transitory memory, fixed memory and removable memory. The memory(ies) may comprise a database for storing data.

As used herein, circuitry may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, circuitry would also cover an implementation of merely a processor (or multiple processors) or a portion of a processor and its (or their) accompanying software and/or firmware. Circuitry would also cover, for example and if applicable to the particular element, a baseband integrated circuit or applications processor integrated circuit for a mobile phone or a similar integrated circuit in a server, a cellular network device, or another network device.

List of abbreviations, which abbreviations may be appended with each other or other characters using e.g. a dash or hyphen (“-”):
AD analog to digital
ADC analog to digital converter
ASIC application-specific integrated circuit
b bits (e.g. 8b)
BERT bidirectional encoder representations from transformers
BMM batch matrix multiplication
Cap capacitor
DNN deep neural network
ep epoch
F1 harmonic mean of precision and recall
FPGA field-programmable gate array
GEMM general matrix multiplication
HW hardware
INT integer
LSB least significant bit
MACC multiply-and-accumulate
MB1 MobileNet-v1 (a neural network model)
MSB most significant bit
NN neural network
prec. precision
PTQ post-training quantization
QAT quantization aware training
SC-PT switched capacitor processing tile (core hardware component)
swcap switch capacitor
SW software
trunc truncation
V voltage
Vdd power supply voltage
W weight vector— input to the multiply-and-accumulate (MACC) operation
X input vector— input to the multiply-and-accumulate (MACC) operation

In the foregoing description, numerous specific details are set forth, such as particular structures, components, materials, dimensions, processing steps, and techniques, in order to provide a thorough understanding of the exemplary embodiments disclosed herein. However, it will be appreciated by one of ordinary skill of the art that the exemplary embodiments disclosed herein may be practiced without these specific details. Additionally, details of well-known structures or processing steps may have been omitted or may have not been described in order to avoid obscuring the presented embodiments.

The description of the present invention has been presented for purposes of illustration and description, but is not intended to be exhaustive or limiting in the form disclosed. Many modifications and variations will be apparent to those of ordinary skill in the art without departing from the scope of the invention. The embodiments were chosen and described in order to best explain the principles of the invention and the practical applications, and to enable others of ordinary skill in the art to understand the invention for various embodiments with various modifications as are suited to the particular uses contemplated.

What is claimed is:

1. An apparatus comprising:
a first plurality of inputs representing an activation input vector;
a second plurality of inputs representing a weight input vector;
an analog multiplier-and-accumulator to generate a first analog voltage representing a first multiply-and-accumulate result for the said first inputs and the second inputs;
a voltage multiplier that takes the said first analog voltage and produces a second analog voltage representing a second multiply-and-accumulate result by multiplying at least one scaling factor to the first analog voltage;
an analog to digital converter configured to convert the said second analog voltage multiply-and-accumulate result into a digital signal using a limited-precision operation during a neural network inference operation; and
a hardware controller configured to determine the at least one scaling factor based on the first multiply-and-accumulate result, or a software controller configured to determine the at least one scaling factor based on the first multiply-and-accumulate result.

2. The apparatus of claim 1, wherein the at least one scaling factor comprises a plurality of independent scaling factors determined during training of a neural network, one independent scaling factor per switched capacitor operation of a layer of a neural network comprising a plurality of layers.

3. The apparatus of claim 1, wherein the apparatus determines the at least one scaling factor during training of a neural network.

4. The apparatus of claim 3, wherein the at least one scaling factor determined during training and used at inference is an integer value.

5. The apparatus of claim 1, further comprising:
an accumulation store charge configured to accumulate a charge corresponding to the second analog voltage multiply-and-accumulate result for a number of iterations.

6. The apparatus of claim 1, further comprising:
a programmable controller configured to control the voltage multiplier, based on the at least one scaling factor.

7. The apparatus of claim 1, wherein the voltage multiplier comprises a plurality of switched capacitors configured in series or parallel.

8. An apparatus comprising:
a first plurality of inputs representing an original activation input vector;
a plurality of voltage multipliers that take the said first plurality of inputs and produce a second plurality of inputs by multiplying at least one scaling factor to voltages of the original activation input vector;
a third plurality of inputs representing a weight input vector;
an analog multiplier-and-accumulator to generate an analog voltage representing a multiply-and-accumulate result for the said second inputs and the third inputs;
an analog to digital converter configured to convert the said analog voltage multiply-and-accumulate result into a digital signal using a limited-precision operation during a neural network inference operation; and
a hardware controller configured to determine the at least one scaling factor based on the multiply-and-accumulate result, or a software controller configured to determine the at least one scaling factor based on the multiply-and-accumulate result.

9. The apparatus of claim 8, wherein the at least one scaling factor comprises a plurality of independent scaling factors, one independent scaling factor per switched capacitor operation of a layer of a neural network comprising a plurality of layers.

10. The apparatus of claim 9, wherein the plurality of independent scaling factors is determined during training of a neural network.

11. The apparatus of claim 8, wherein the apparatus determines the at least one scaling factor during training of a neural network.

12. The apparatus of claim 11, wherein the at least one scaling factor determined during training and used at inference is an integer value.

13. The apparatus of claim 8, further comprising:
an accumulation store charge configured to accumulate a charge corresponding to the analog voltage multiply-and-accumulate result for a number of iterations.

14. The apparatus of claim 8, further comprising:
at least one programmable controller configured to control the plurality of voltage multipliers, based on the at least one scaling factor.

15. A method comprising:
receiving a first plurality of inputs representing an activation input vector;
receiving a second plurality of inputs representing a weight input vector;
generating, with an analog multiplier-and-accumulator, an analog voltage representing a multiply-and-accumulate result for the first plurality of inputs and the second plurality of inputs;
converting, with an analog to digital converter, the analog voltage multiply-and-accumulate result into a digital signal using a limited-precision operation during an inference operation of a neural network; and
determining, during training or calibration of the neural network, at least one scaling factor used to amplify the first plurality of inputs or to amplify the analog voltage multiply-and-accumulate result.

16. The method of claim 15, further comprising:
determining a plurality of independent scaling factors, comprising determining one independent scaling factor per switched capacitor operation of a layer of a neural network comprising a plurality of layers, wherein the at least one scaling factor comprises the plurality of independent scaling factors.

17. The method of claim 15, wherein amplifying the first plurality of inputs comprises producing, with a plurality of voltage multipliers, an amplified first plurality of inputs by multiplying the at least one scaling factor to voltages of the activation input vector, the method further comprising generating, with the analog multiplier-and-accumulator, the analog voltage multiply-and-accumulate result for the amplified first plurality of inputs.

18. The method of claim 15, wherein amplifying the analog voltage comprises producing, with a voltage multiplier, an amplified analog voltage multiply-and-accumulate result by applying the at least one scaling factor to the analog voltage multiply-and-accumulate result, the method further comprising converting, with the analog to digital converter, the amplified analog voltage multiply-and-accumulate result into the digital signal using the limited-precision operation during the inference operation of the neural network.

19. The method of claim 18, further comprising:
configuring a plurality of switched capacitors of the voltage multiplier in series; or
configuring the plurality of switched capacitors of the voltage multiplier in parallel.

20. The method of claim 15, further comprising:
accumulating a charge corresponding to the analog voltage multiply-and-accumulate result for a number of iterations.
